(19) United States
(12) Patent Application Publication
(10) Pub. No.: US 2011/0258581 A1
(43) Pub. Date: Oct. 20, 2011

(54) METHOD FOR ADJUSTING SIZE OF AN ICON AND RELATED HANDHELD DEVICE

(76) Inventor: Wei-Han Hu, Taipei County (TW)

(21) Appl. No.: 12/759,717

(22) Filed: Apr. 14, 2010

(51) Int. Cl. G06F 3/048

(52) U.S. Cl. 715/811

(57) ABSTRACT

A method for adjusting a size of an icon displayed by a navigation device is disclosed. The method includes the navigation device generating a setup value respectively for each icon by calculating a selected frequency of each icon or by setting an icon menu and the navigation device determining whether to zoom in the corresponding icon according to the setup value.

### BACKGROUND OF THE INVENTION

1. Field of the Invention

The present invention relates to a display method and a related device, and more specifically, to a method for adjusting sizes of icons and a related handheld device.

2. Description of the Prior Art

With development of electronic technology, a handheld device has become one of indispensable supplies in daily life, such as a navigation device.

A conventional navigation device usually includes a map data base for providing navigation paths displayed on a screen of the navigation device. The navigation device is usually embedded in or disposed on a dashboard of a car by absorbing components or other fixing components for use convenience. Besides the said navigation function, the navigation device has also developed many additional functions related to navigation information for meeting user needs, such as a tour guide function and a POI (Point of Interest) search function. Thus, there are more and more icons representing different functions displayed on the navigation device. Although these additional functions may provide a user with convenient and various navigation services, numerous icons corresponding to these additional functions may also cause the user a lot of inconvenience.

For example, the situation of overcrowded icons being displayed in one single visible page may occur since a navigation device usually has a small screen (3.5″˜7″). This display problem may not only cause a user to be incapable of selecting frequently-used icons quickly, but may also increase difficulty in icon identity and icon operation since the display area of each icon is reduced correspondingly, especially when the user is driving a car or is incapable of viewing the handheld device attentively. Furthermore, the said problem may even cause an infirm user or a user having poor eyesight much more inconvenience.

### SUMMARY OF THE INVENTION

The present invention provides a method for adjusting a size of an icon on a handheld device, the handheld device having a display unit for displaying a plurality of icons, the method comprising the handheld device generating a setup value for each icon respectively by calculating a selected frequency of each icon or by setting an icon menu; and the handheld device controlling whether the display unit zooms in a corresponding icon according to the setup value.

The present invention further provides a handheld device capable of zooming in icons, the handheld device comprising a display unit for displaying a plurality of icons; a setup unit for generating a corresponding setup value for each icon by calculating a selected frequency of each icon or by setting an icon menu; and a control unit for controlling whether the display unit zooms in a corresponding icon according to the setup value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a handheld device according to a preferred embodiment of the present invention.

FIG. 2 is a flowchart of a method for adjusting the sizes of the icons displayed by the handheld device according to a preferred embodiment of the present invention.

FIG. 3 is a diagram of a display unit on the handheld device in FIG. 1 zooming in the main icons.

FIG. 4 is a diagram of the display unit zooming in the main icons according to another preferred embodiment of the present invention.

FIG. 5 is a flowchart of a method for adjusting the sizes of the icons displayed by the handheld device according to another preferred embodiment of the present invention.

FIG. 6 is a diagram of the display unit of the handheld device zooming in the main icons in a 2×2 arrangement according to another preferred embodiment of the present invention.

FIG. 7 is a diagram of the display unit of the handheld device zooming in the main icons in a 2×1 arrangement according to another preferred embodiment of the present invention.

### DETAILED DESCRIPTION

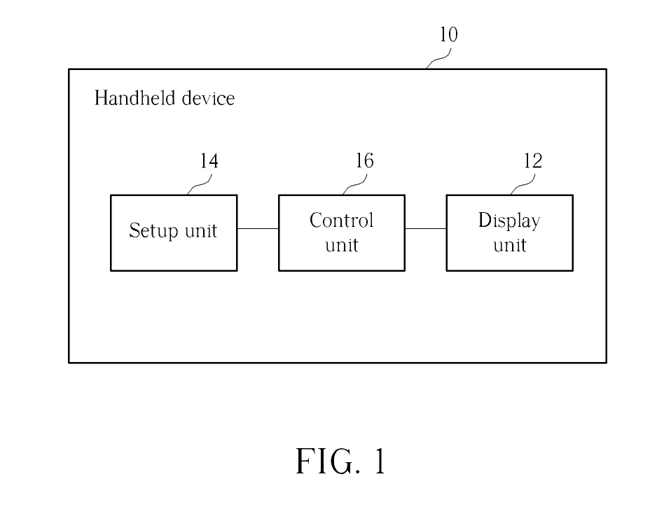

Please refer to FIG. 1, which is a functional block diagram of a handheld device 10 according to a preferred embodiment of the present invention. In the present invention, the handheld device 10 is preferably a navigation device but is not limited thereto, meaning that the handheld device 10 may also be other handheld device (e.g. a mobile phone). In the following, detailed description for the present invention is provided on the premise that the handheld device 10 is a navigation device. Since applications of the present invention for other handheld devices may be reasoned by analogy, the related description is therefore omitted herein.

As shown in FIG. 1, the handheld device 10 includes a display unit 12, a setup unit 14, and a control unit 16. The display unit 12 is used for displaying a plurality of icons. The plurality of icons represents functions provided by the handheld device 10. In this embodiment, the plurality of icons preferably includes a plurality of main icons (e.g. “GO” or “EXPLORE”) and a plurality of sub icons (e.g. “Destination input” or “Scenic-spot introduction”). The display unit 12 may be a liquid crystal display screen or a touch panel. In other words, via the display unit 12, a user may not only view the icons, but may also input instructions to the handheld device 10. The setup unit 14 is used for generating a corresponding setup value for each icon respectively. The control unit 16 is used for controlling whether the display unit 12 zooms in an icon according to the corresponding setup value generated by the setup unit 14.

In this embodiment, the setup value respectively for each icon may preferably correspond to an active calculated result for selected frequencies of the icons, or a passive selected result after setting an icon menu provided by the setup unit 14. More detailed description for the two different kinds of methods mentioned above is provided as follows.

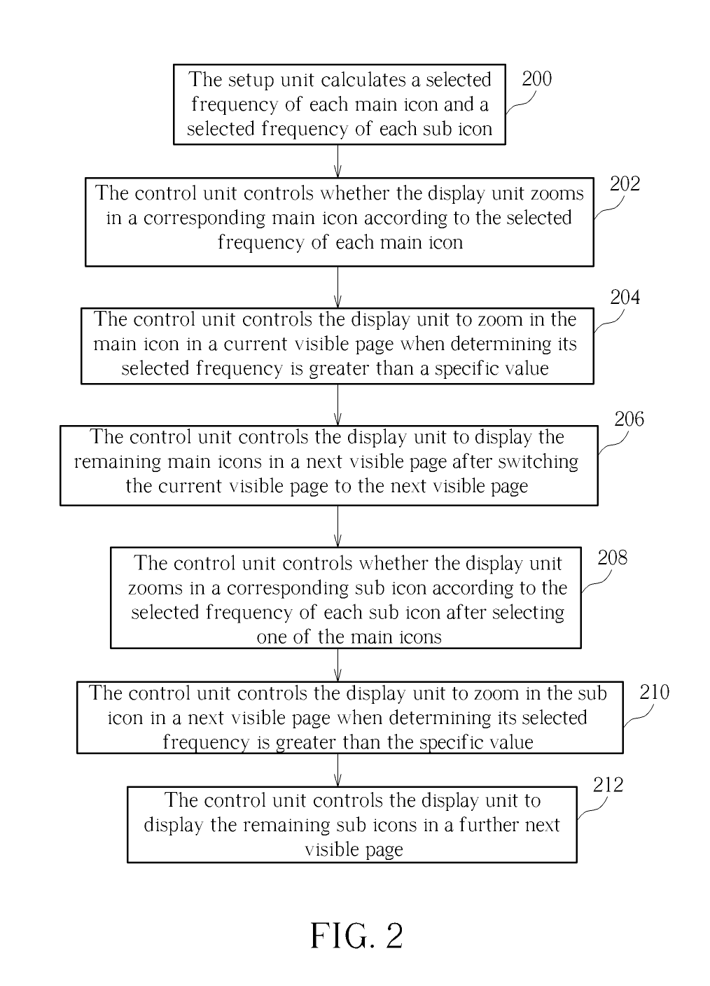

Please refer to FIG. 2, which is a flowchart of a method for adjusting the sizes of the icons displayed by the handheld device 10 according to a preferred embodiment of the present invention. The method includes the following steps.

Step 200: The setup unit 14 calculates a selected frequency of each main icon and a selected frequency of each sub icon respectively;

Step 202: The control unit 16 controls whether the display unit 12 zooms in at least one main icon according to the selected frequency of each main icon calculated by the setup unit 14;

Step 204: The control unit 16 controls the display unit 12 to zoom in the main icon in a current visible page when determining its selected frequency is greater than the specific value;

Step 206: The control unit 16 controls the display unit 12 to display the remaining main icons in a next visible page after switching the current visible page to the next visible page;

Step 208: The control unit 16 controls whether the display unit 12 zooms in at least one sub icon according to the selected frequency of each sub icon calculated by the setup unit 14 after selecting one of the main icons;

Step 210: The control unit 16 controls the display unit 12 to zoom in the sub icon in a next visible page when determining its selected frequency is greater than the specific value;

Step 212: The control unit 16 controls the display unit 12 to display the remaining sub icons in a further next visible page after switching the next visible page to the further next visible page.

In the following, the aforementioned steps are described in detail. In Step 200, the setup unit 14 calculates the selected times of each main icon and the selected times of each sub icon displayed on the display unit 12 when a user operates the handheld device 10, so that the selected frequency of each main icon and the selected frequency of each sub icon can be calculated accordingly. Next, in Step 202, the control unit 16 controls whether the display unit 12 zooms in at least one main icon according to the selected frequency of each main icon calculated by the setup unit 14. That is, the control unit 16 may determine if the selected frequency of each main icon is greater than the specific value. The said specific value may correspond to selected times of an icon during a specific period, and may be a predetermined value set in the handheld device 10 or be set manually by the user himself. Subsequently, according to the said determined result, the control unit 16 may control the display unit 12 to zoom in the main icon having the selected frequency greater than the specific value in the current visible page (Step 204) and display the remaining main icons in the next visible page after switching the current visible page to the next visible page (Step 206).

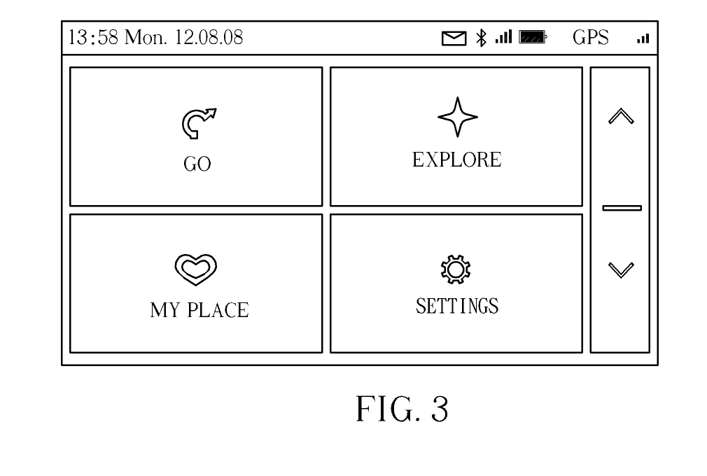

FIG. 3, which is a diagram of the display unit 12 on the handheld device 10 in FIG. 1 zooming in the main icons, is taken as an example for description of Step 204 and Step 206. If the specific value is 5 (times per hour), the four main icons representing the four main functions of the handheld device 10 respectively (i.e. “GO”, “EXPLORE”, “MY PLACES”, and “SETTINGS”) are selected ten times in one hour by a user, and the remaining main icons are selected less than five times, the control unit 16 may accordingly control the display unit 12 to zoom in the said four icons, which are regarded as the frequently-used icons for the user, in a visible page as shown in FIG. 3. In such a manner, the user may recognize and select the four icons quickly when operating the handheld device 10.

As for the remaining main icons, which may be regarded as infrequently-used icons, the control unit 16 may control the display unit 12 to display them in a next visible page. That is, if the user wants to select the remaining main icons, the user just needs to operate the display unit 12 to switch the visible page as shown in FIG. 3 to the next visible page. In such a manner, the user may view the remaining main icons in the next visible page accordingly. Furthermore, if the control unit 16 determines that all the selected frequencies of the main icons are less than the specific value, the control unit 16 may control the display unit 12 to display each main icon in original size. Display of the sub icons is the same as that of the main icons in the said condition, and the related description is therefore omitted herein.

Next, if the user selects one of the main icons, the control unit 16 may control whether the display unit 12 zoom in at least one sub icon according to the selected frequency of each sub icon calculated by the setup unit 14 (Step 208). As mentioned above, at this time, the control unit 16 may determine if the selected frequency of each sub icon is greater than the specific value. Subsequently, according to the determined result, the control unit 16 may control the display unit 12 to zoom in the sub icon having the selected frequency greater than the specific value in the next visible page (Step 210), and then display the remaining sub icons in the further next visible page (Step 212). Since the method for displaying the sub icons is similar to that for displaying the main icons mentioned above, it is therefore omitted herein for simplicity.

The specific value for the main icons may be or may be not the same as that for the sub icons. In summary, via the method for actively zooming in at least one icon having the selected frequency greater than the specific value, the user may select the frequently-used icons quickly while operating the handheld device 10.

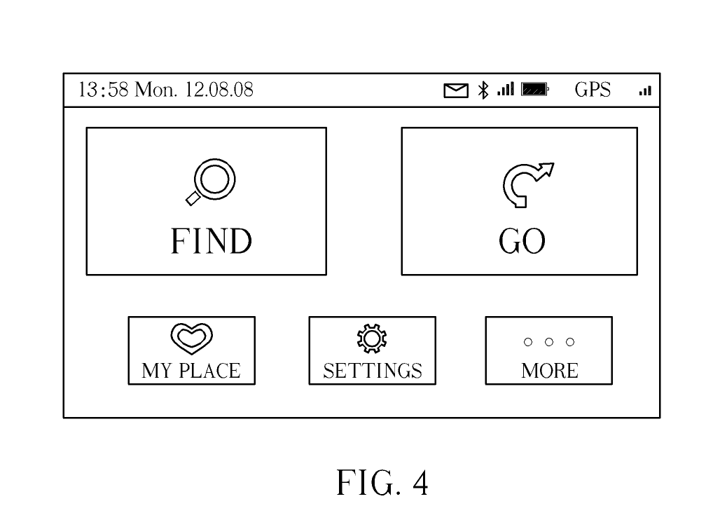

Furthermore, it should be mentioned that the method for displaying the icons is not limited to the said embodiment. Please refer to FIG. 4, which is a diagram of the display unit 12 zooming in at least one main icon according to another preferred embodiment of the present invention. As shown in FIG. 4, the control unit 16 may control the display unit 12 to zoom in at least one main icon (two shown in FIG. 4) having the selected frequency greater than the specific value and zoom out the remaining main icons in a visible page as shown in FIG. 4, so as to achieve the purpose of displaying more icons in one single visible page. Similarly, the method for displaying the sub icons may be the same as the said method. As for which display design is utilized, it depends on practical applications of the handheld device 10.

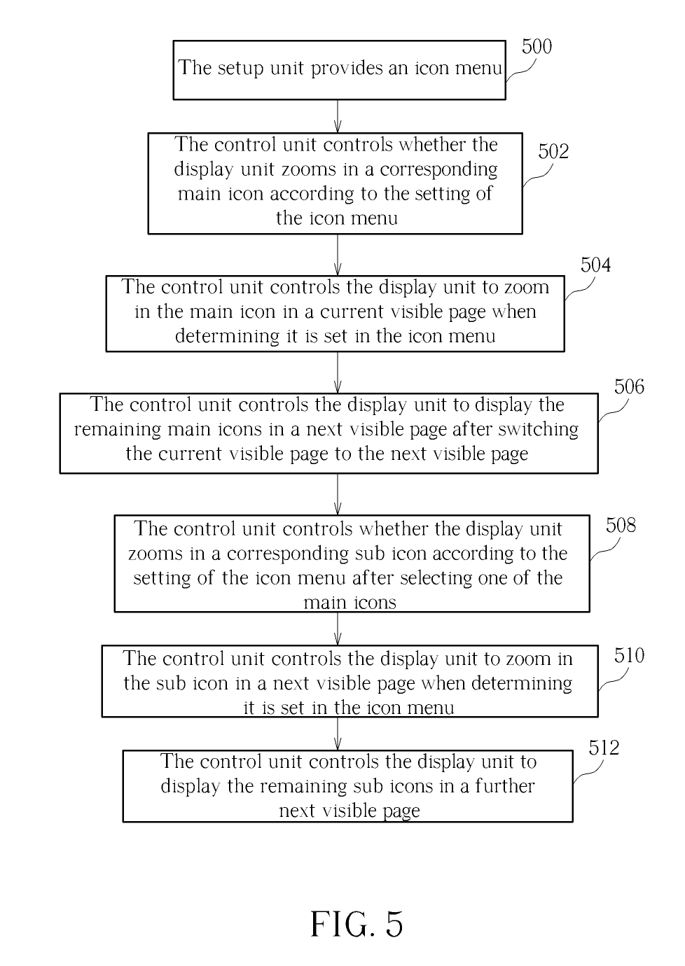

Next, please refer to FIG. 5, which is a flowchart of a method for adjusting the sizes of the icons displayed by the handheld device 10 according to another preferred embodiment of the present invention. The method includes the following steps.

Step 500: The setup unit 14 provides an icon menu;

Step 502: The control unit 16 controls whether the display unit 12 zooms in at least one main icon according to the setting of the icon menu provided by the setup unit 14;

Step 504: The control unit 16 controls the display unit 12 to zoom in the main icon set in the icon menu in a current visible page;

Step 506: The control unit 16 controls the display unit 12 to display the remaining main icons in a next visible page after switching the current visible page to the next visible page;

Step 508: The control unit 16 controls whether the display unit 12 zooms in at least one sub icon according to the setting of the icon menu after selecting one of the main icons;

Step 510: The control unit 16 controls the display unit 12 to zoom in the sub icon set in the icon menu in a next visible page;

Step 512: The control unit 16 controls the display unit 12 to display the remaining sub icons in a further next visible page after switching the next visible page to the further next visible page.

More detailed description for the said steps is provided as follows. First, before a user wants to operate the handheld device 10, the setup unit 14 may provide the icon menu as mentioned in Step 500 in advance. The icon menu may preferably include icon options corresponding to the main icons and the sub icons respectively, so that the user can manually select the most-frequently-used or the predictably-used icons via the icon menu.

Next, in Step 502, the control unit 16 controls whether the display unit 12 zooms in at least one main icon according to the said setting of the icon menu. That is, as shown in FIG. 3, the control unit 16 may control the display unit 12 to zoom in at least one main icon set in the icon menu in the current visible page (Step 504) and display the remaining main icons in the next visible page after switching the current visible page to the next visible page (Step 506).

As for the remaining main icons, the control unit 16 may control the display unit 12 to display them in a next visible page. That is, if the user wants to select the remaining main icons, the user just needs to operate the display unit 12 to switch the current visible page as shown in FIG. 3 to the next visible page. In such a manner, the user may view the remaining main icons in the next visible page accordingly. Furthermore, if the control unit 16 determines that all the main icons are not set in the icon menu, the control unit 16 may control the display unit 12 to display each main icon in original size. Display of the sub icons is the same as that of the main icons in the said condition.

Next, if the user selects one of the main icons, the control unit 16 may control whether the display unit 12 zoom in at least one sub icon according to the setting of the icon menu (Step 508). That is, the control unit 16 may control the display unit 12 to zoom in at least one sub icon set in the icon menu in the next visible page (Step 510), and then display the remaining sub icons in the further next visible page (Step 512).

In summary, compared with the method for actively calculating the selected frequency of each icon, this embodiment involves passively controlling whether to zoom in the icons according to the setting of the icon menu manually set by the user. However, no matter which method is utilized, the present invention can allow a user to select the frequently-used icons quickly by zooming in these icons when operating the handheld device 10. In such a manner, use convenience of the handheld device 10 in icon identity and icon selection may be increased greatly.

It should be mentioned that the method for determining whether the display unit 12 zooms in the main icons and the sub icons is not limited to the said embodiment. That is, the determining principles for zooming in the icons in the aforementioned embodiments may be mutually applied for the main icons and the sub icons.

For example, as far as the main icons are concerned, the control unit 16 may control whether the display unit 12 zooms in the corresponding main icons according to the setting of the icon menu set by a user. On the other hand, the control unit 16 may control whether the display unit 12 zooms in the corresponding sub icons by calculating the selected frequency of each sub icon instead. In other words, for the display setting of the handheld device 10, a user just needs to set the setting of whether to zoom in the main icons. As for whether to zoom in the sub icons, it can be determined actively by the handheld device 10 according to the selected frequency of each sub icon. In such a manner, the setup process of the handheld device 10 may be simplified accordingly.

Similarly, the display principles for the display unit 12 in the aforementioned embodiments may also be mutually applied for the main icons and the sub icons. For example, the control unit 16 may control the display unit 12 to zoom in the main icons set by a user in a current visible page and display the remaining main icons in a next visible page. On the other hand, the control unit 16 may control the display unit 12 to zoom in the sub icons set in the icon menu and zoom out the remaining sub icons in the same visible page instead.

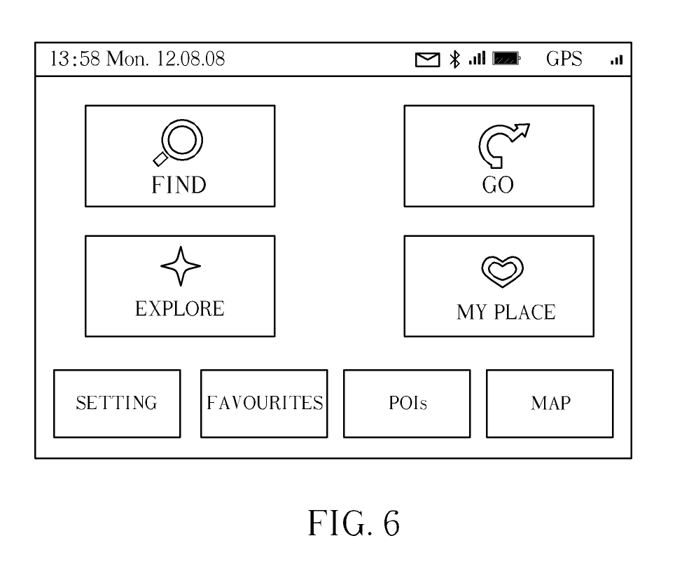

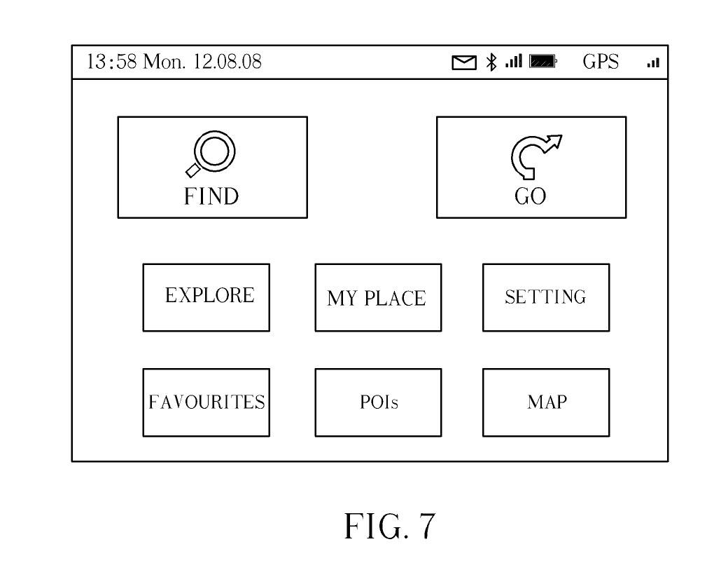

Furthermore, the method for zooming in the icons is not limited to the said embodiments, meaning that it may also vary with a user's viewing preference. Please refer to FIG. 6 and FIG. 7. FIG. 6 is a diagram of the display unit 12 of the handheld device 10 zooming in the main icons in a 2×2 arrangement according to another preferred embodiment of the present invention. FIG. 7 is a diagram of the display unit 12 of the handheld device 10 zooming in the main icons in a 2×1 arrangement according to another preferred embodiment of the present invention. It is assumed that there are four main icons having the selected frequencies greater than the specific value. First, the setup unit 14 may provide a viewing-preference menu before the control unit 16 controls the display unit 12 to zoom in the four main icons. Subsequently, via the viewing-preference menu, a user may operate the display unit 12 to zoom in the four main icons in a specific arrangement, such as a 2×2 matrix (as shown in FIG. 6) or a 2×1 matrix (as shown in FIG. 7). In this example, it is assumed that the user sets the display unit 12 to zoom in the four main icons in a 2×2 arrangement via the viewing-preference menu. In such a manner, the control unit 16 may control the display unit 12 to zoom in the four main icons and zoom out the remaining main icons having the selected frequencies less than the specific value in the visible page as shown in FIG. 6. Thus, the purposes of conforming to a user's viewing preference may be achieved.

Similarly, if the user sets the display unit 12 to zoom in the four main icons in a 2×1 arrangement via the viewing-preference menu, the control unit 16 may control the display unit 12 to selectively zoom in two of the four main icons and zoom out the remaining main icons having the selected frequencies less than the specific value in the visible page as shown in FIG. 7, and then zoom in the remaining two main icons having the selected frequencies greater than the specific value in a next visible page. Thus, the purposes of stepwise zooming in the icons and conforming to a user's viewing preference may be achieved.

It should be noted that the two main icons having the selected frequencies greater than the specific value, which are displayed in the visible page as shown in FIG. 7, may preferably be selected sequentially based on the selected frequencies of the four main icons or be selected randomly by the control unit 16.

On the other hand, if there are only two main icons having the selected frequencies greater than the specific value and a user sets the display unit 12 to zoom in the main icons in a 2×2 arrangement by the viewing-preference menu, the control unit 16 may control the display unit 12 to zoom in the two main icons and another two main icons in the visible page as shown in FIG. 6. The two main icons, selected frequencies of which are less than the specific value, may preferably be selected sequentially based on the selected frequency of each main icon or be selected randomly by the control unit 16.

In such a manner, no matter which embodiment is utilized, the present invention may allow a user to view the icons provided by the handheld device 10 in his favorite way by manually setting the viewing-preference menu, so as to flexibly meet different users' viewing preferences. Thus, flexibility of the handheld device 10 in use may be increased greatly. The method for providing the viewing-preference menu may also be applied for display of the sub icons or other embodiments of the present invention.

Compared with the prior art, in which overcrowded icons are displayed in one single visible page of a screen on a handheld device (e.g. a navigation device), the handheld device provided by the present invention utilizes a method for actively calculating selected frequencies of icons or a method for passively providing an icon menu to achieve the purpose of allowing the user to select frequently-used icons quickly when operating the handheld device. In such a manner, even if a user, especially an infirm user or a user having poor eyesight, is driving a car or is incapable of viewing the handheld device attentively, the present invention may not only allow the user to select the frequently-used icons quickly, but may also considerably increase use convenience of the handheld device in icon identity and icon operation.

Those skilled in the art will readily observe that numerous modifications and alterations of the device and method may be made while retaining the teachings of the invention.

What is claimed is:

1. A method for adjusting a size of an icon on a handheld device, the handheld device having a display unit for displaying a plurality of icons, the method comprising:
the handheld device generating a setup value for each icon respectively by calculating a selected frequency of each icon or by setting an icon menu; and
the handheld device controlling whether the display unit zooms in a corresponding icon according to the setup value.

2. The method of claim 1, wherein the handheld device generating the setup value for each icon respectively comprises:
the handheld device generating the setup value for each main icon and each sub icon in the plurality of icons respectively.

3. The method of claim 2, wherein the handheld device controlling whether the display unit zooms in the corresponding icon according to the setup value comprises:
the handheld device controlling the display unit to zoom in at least one corresponding main icon in a current visible page according to the setup value of each main icon and display the remaining main icons in a next visible page after switching the current visible page to the next visible page.

4. The method of claim 2, wherein the handheld device controlling whether the display unit zooms in the corresponding icon according to the setup value comprises:
the handheld device controlling the display unit to zoom in at least one corresponding main icon and zoom out the remaining main icons in a current visible page according to the setup value of each main icon.

5. The method of claim 2, wherein the handheld device controlling whether the display unit zooms in the corresponding icon according to the setup value comprises:
the handheld device controlling the display unit to zoom in at least one corresponding sub icon according to the setup value of each sub icon in a next visible page after selecting one of the main icons and display the remaining sub icons in a further next visible page.

6. The method of claim 2, wherein the handheld device controlling whether the display unit zooms in the corresponding icon according to the setup value comprises:
the handheld device controlling the display unit to zoom in at least one corresponding sub icon and zoom out the remaining sub icons in a next visible page according to the setup value of each sub icon after selecting one of the main icons.

7. The method of claim 1, wherein the handheld device controlling whether the display unit zooms in the corresponding icon according to the setup value comprises:
the handheld device controlling the display unit to zoom in the corresponding icon when determining its selected frequency is greater than a specific value.

8. The method of claim 7, wherein the handheld device controlling whether the display unit zooms in the corresponding icon according to the setup value comprises:
the handheld device providing a viewing-preference menu; and
the handheld device controlling the display unit to zoom in at least one corresponding icon in a specific arrangement according to the selected frequency of each icon and the setting of the viewing-preference menu.

9. The method of claim 1, wherein the handheld device controlling whether the display unit zooms in the corresponding icon according to the setup value comprises:
the handheld device controlling the display unit to zoom in the corresponding icon set in the icon menu.

10. The method of claim 9, wherein the handheld device controlling whether the display unit zooms in the corresponding icon according to the setup value comprises:
the handheld device providing a viewing-preference menu; and
the handheld device controlling the display unit to zoom in at least one corresponding icon in a specific arrangement according to the setting of the icon menu and the setting of the viewing-preference menu.

11. A handheld device capable of zooming in icons, the handheld device comprising:
a display unit for displaying a plurality of icons;
a setup unit for generating a corresponding setup value for each icon by calculating a selected frequency of each icon or by setting an icon menu; and
a control unit for controlling whether the display unit zooms in a corresponding icon according to the setup value.

12. The handheld device of claim 11, wherein the setup unit is used for generating the corresponding setup value for each main icon and each sub icon in the plurality of icons respectively.

13. The handheld device of claim 12, wherein the control unit is used for controlling whether the display unit zooms in the corresponding main icon according to the setup value of each main icon.

14. The handheld device of claim 13, wherein the control unit is used for controlling the display unit to zoom in at least one main icon in a current visible page and display the remaining main icons in a next visible page after switching the current visible page to the next visible page.

15. The handheld device of claim 13, wherein the control unit is used for controlling the display unit to zoom in at least one main icon and zoom out the remaining main icons in a current visible page according to the setup of each main icon.

16. The handheld device of claim 12, wherein the control unit is used for controlling whether the display unit zooms in the corresponding sub icon according to the setup value of each sub icon after selecting one of the main icons.

17. The handheld device of claim 16, wherein the control unit is used for controlling the display unit to zoom in at least one sub icon in a next visible page after selecting one of the main icons and display the remaining sub icons in a further next visible page after switching the next visible page to the further next visible page.

18. The handheld device of claim 16, wherein the control unit is used for controlling the display unit to zoom in at least one sub icon and zoom out the remaining sub icons in a next visible page according to the setup of each sub icon.

19. The handheld device of claim 11, wherein the control unit is used for controlling the display unit to zoom in the corresponding icon when determining its selected frequency is greater than a specific value.

20. The handheld device of claim 19, wherein the control unit is used for controlling the display unit to zoom in at least one icon in a current visible page when determining its selected frequency is greater than the specific value and display the remaining icons in a next visible page after switching the current visible page to the next visible page.

21. The handheld device of claim 19, wherein the control unit is used for controlling the display unit to zoom in at least one icon when determining its selected frequency is greater than the specific value and zoom out the remaining icons in a current visible page.

22. The handheld device of claim 11, wherein the control unit is used for controlling the display unit to zoom in the corresponding icon set in the icon menu.

23. The handheld device of claim 22, wherein the control unit is used for controlling the display unit to zoom in at least one icon set in the icon menu in a current visible page and display the remaining icons in a next page after switching the current visible page to the next visible page.

24. The handheld device of claim 22, wherein the control unit is used for controlling the display unit to zoom in at least one icon set in the icon menu and zoom out the remaining icons in a current visible page.

25. The handheld device of claim 11, wherein the setup unit is used for providing a viewing-preference menu, and the control unit is used for controlling the display unit to zoom in at least one icon in a specific arrangement according to the setup value of each icon and the setting of the viewing-preference menu.
